(19) United States
(12) Patent Application Publication
(10) Pub. No.: US 2009/0065335 A1
(43) Pub. Date: Mar. 12, 2009

(54) Multi-functional keypad module for a mobile phone

(76) Inventors: Wen-Chin Yao, Rueifang Township (TW); Ming-Yu Hua, Taipei City (TW); Hsien-Kuo Kao, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,082

(22) Filed: Jul. 16, 2008

(30) Foreign Application Priority Data
Sep. 7, 2007 (TW) 96215100

(51) Int. Cl. H01H 9/00

(52) U.S. Cl. 200/310

(57) ABSTRACT

A multi-functional keypad module for a mobile phone includes a circuit board, a light-emitting element, a soft light-guiding rubber layer, an optical touch layer, and a key layer. The soft light-guiding rubber layer is provided on the circuit board and has a plurality of protrusions each corresponding to the circuit board; thereby a feedback feeling from a pressing action and a light-guiding effect can be obtained. The optical touch layer is provided on the soft light-guiding rubber layer, in order to continue the optically enhanced touch-control and the feedback feeling. The key layer is provided on the optical touch layer, with a plurality of keys respectively corresponding to one of the protrusion, thereby completes and achieves the optically enhanced touch-control effect and feedback feeling. Via the above arrangement, the keypad module of a mobile phone has multiple functions of light guiding, touch-control, and feedback feeling from a pressing action.

### BACKGROUND OF THE INVENTION

1. Field of the Invention

The present invention relates to a keypad module of a mobile phone, and in particular to a keypad module of a mobile phone with a key layer, an optical touch layer, and a soft light-guiding rubber layer combined one on top of the other in sequence, thereby provides multi-functions of light guiding, touch-control, and feedback feeling from a pressing action on the keypad.

2. Description of Related Art

With the development of science and technology, mobile phones have become necessary electronic communication products for modern people. In order to allow a user to input data easily, the electronic product is equipped with an individual writing region or touch screen, so that the user can input data by means of writing or touching. Since the size (especially thickness) of the mobile phone is required to be made more compact, the contacting area among a plurality of keys on the keypad is also reduced. Therefore, in practice use, it is difficult for the user to press the keys accurately or be certain whether the pressing action has been completed.

Please refer to FIG. 1, which is an assembled view showing a conventional keypad module. The keypad module 10a includes a circuit board 11a, a rubber layer 12a, a light-guiding layer 13a, a light-emitting element 14a, an adhesive layer 15a, and a key assembly 16a. The surface of the circuit board 11a is formed with a plurality of electrically conductive lines (not shown). The rubber layer 12a is provided on the circuit board 11a to correspond to the electrically conductive lines. The rubber layer 12a has a plurality of protrusions 120a for contacting the electrically conductive lines 12a. The light-emitting layer 13a is disposed on the rubber layer 12a. The light-emitting element 14a is disposed on the circuit board 11a to correspond to the sides of the rubber layer 12a and the light-guiding layer 13a, thereby providing a light source to the light-guiding layer 13a and guiding the light source. The adhesive layer 15a is provided on the light-guiding layer 13a. The key assembly 16a is provided on the adhesive layer 15. Via the adhesive layer 15a, the key assembly 16a can be adhered onto the light-guiding layer 13a, so that the light source can be guided to the key assembly 16a to generate a light-guiding and light-emitting effect. The key assembly 16a has a plurality of keys 160a. Each key 160a corresponds to a protrusion 120a of the rubber layer 12a respectively.

Via the above arrangement, the light emitted by the light-emitting element 14a can be guided to each key 160a via the light-guiding layer 13a. The pressing of each key 160a allows the corresponding protrusion 120a to touch the electrically conductive lines on the circuit board 11a, thereby inputting signals into the electronic circuit to control the associated keys.

In the conventional keypad module of a mobile phone, since the rubber layer 12a and the key assembly 16a cannot be pressed accurately due to either insufficient force, miniaturization of mobile phone, or loose contact from repeated use, the rubber layer 12a may not always achieve contact to the lines of the circuit board 11a from pressing action. As a result, the signals may be inputted inaccurately. Therefore, the user has to exert a larger force to avoid the problems of inaccurate pressing.

On the other hand, if the user exerts an excessive force, the protrusions 120a of the rubber layer 12a may suffer elastic fatigue. After the elastic fatigue is accumulated for a long time, the whole elasticity of the rubber layer 12a may be deteriorated seriously, so that the feedback feeling for a pressing action will be lost. As a result, the whole key 160a cannot be brought into sufficient contact with the protrusions 120a.

According to the above, the conventional keypad module still has some problems in practical use. Consequently, because of the above limitation resulting from the technical design of prior art, the inventor strives via real world experience and academic research to develop the present invention, which can effectively improve the limitations described above.

### SUMMARY OF THE INVENTION

The object of the present invention is to provide a multi-functional keypad module for a mobile phone, in which a soft light-guiding rubber layer, an optical touch layer, and a key layer are combined with each other, so that the structure thickness of the keypad module for the mobile phone is reduced. Furthermore, an optically enhanced touch-control effect (the result of light guiding and touch control) can be obtained. With the reduced amount of material, the light-guiding effect can be achieved efficiently. Furthermore, due to the elasticity, a feedback feeling from the pressing action on the keypad can be generated.

In order to achieve the above objects, the present invention provides a multi-functional keypad module for a mobile phone, which includes a circuit board, a light-emitting element, a soft light-guiding rubber layer, an optical touch layer, and a key layer. The light-emitting element is electrically connected to a circuit board. The soft light-guiding rubber layer is provided on the circuit board. One side of the soft light-guiding rubber layer corresponds to the light-emitting element. The soft light-guiding rubber layer is provided with a plurality of protrusions. Each of the protrusions is arranged at intervals to face the circuit board respectively, thereby generating a feedback feeling from a pressing action. The optical touch layer is provided on the soft light-guiding rubber layer; in order to achieve an optically enhanced touch-control effect. The key layer is provided on the optical touch layer, thereby achieving and completing the optically enhanced touch-control effect. The key layer has a plurality of keys, and each key corresponds to a protrusion respectively.

In order to achieve the above object, the present invention also provides a multi-functional keypad module for a mobile phone, which includes a soft elastic rubber layer, an optically touch layer, and a key layer. The soft elastic rubber layer has a plurality of protrusions. The optically touch layer is provided on the soft elastic rubber layer. The optical touch layer and the soft elastic rubber layer together generate a feedback feeling for a pressing action. The key layer is provided on the optically touch layer. The key layer has a plurality of keys. Each key corresponds to a protrusion respectively.

In order to achieve the above objects, the present invention further provides a multi-functional keypad module for a mobile phone, which includes a soft rubber layer, an optical touch layer and a key layer. The optical touch layer is provided on the soft rubber layer. The key layer is provided on the optical touch layer.

Via the above arrangement, the keypad module of the mobile phone can generate multiple functions including light-guiding, touch control, and generating a feedback feeling for the pressing action; wherein the light-guiding and touch control functions are combined and referred to as optically enhanced touch-control.

In order to further understand the characteristics and technical contents of the present invention, a detailed description relating thereto will be made with reference to the accompanying drawings. However, the drawings are illustrative only, but are not used to limit the scope of the present invention.

### BRIEF DESCRIPTION OF THE DRAWINGS

FIG. 1 is an assembled view showing a conventional keypad module of a mobile phone;

FIG. 2 is a perspective view showing the multi-functional keypad module for a mobile phone according to an embodiment of the present invention;

FIG. 3 is an exploded view showing the multi-functional keypad module for a mobile phone according to an embodiment of the present invention;

FIG. 4 is an assembled view showing the multi-functional keypad module for a mobile phone according to an embodiment of the present invention; and

FIG. 5 is an assembled view showing the multi-functional keypad module for a mobile phone according to another embodiment of the present invention.

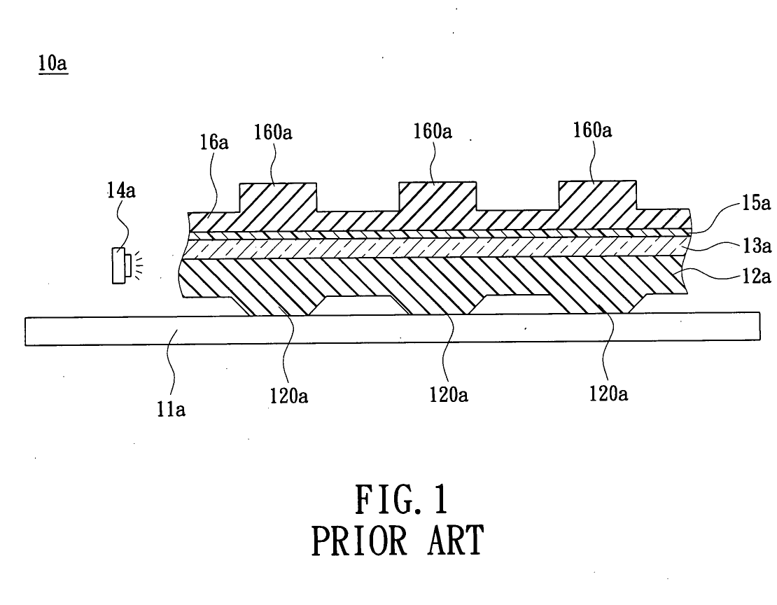

### DETAILED DESCRIPTION OF THE PREFERRED EMBODIMENTS

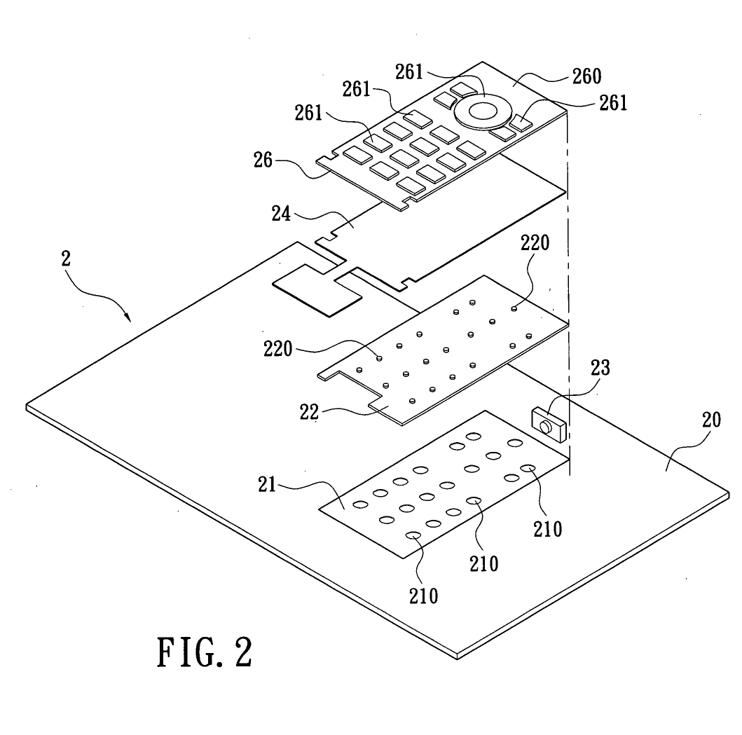

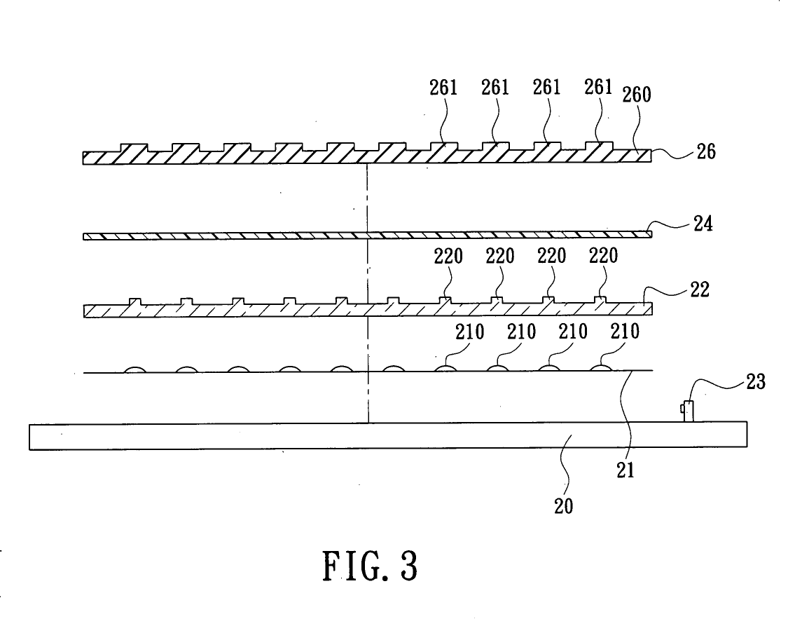

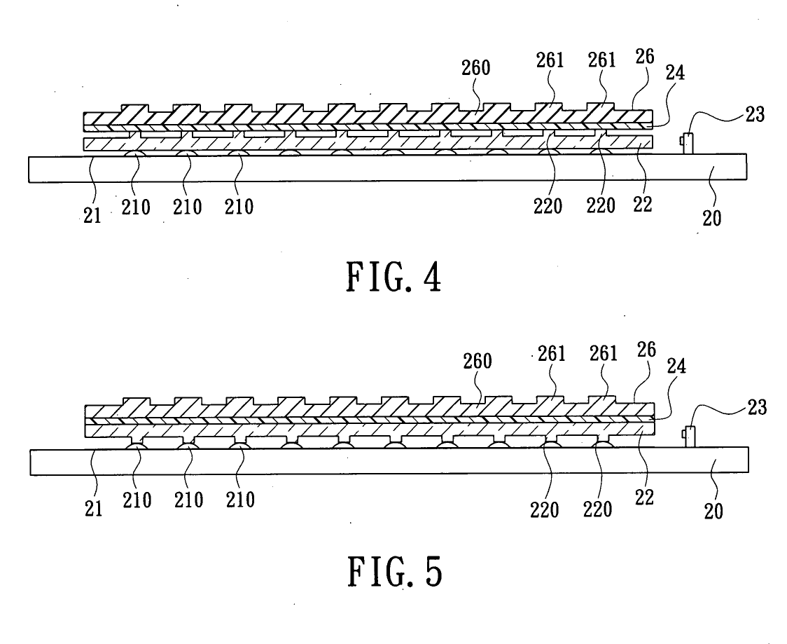

Please refer to FIGS. 2 to 4. FIG. 2 is a perspective view showing the multi-functional keypad module for a mobile phone according to one embodiment of the present invention, FIG. 3 is an exploded view thereof and FIG. 4 is an assembled view. The present invention provides a keypad module 2 of a mobile phone, which includes a circuit board 20, a soft light-guiding rubber layer 22, a light-emitting element 23, an optical touch layer 24, and a key layer 26.

The circuit board 20 is a printed circuit board, and is made of copper, aluminum, iron, or other soft substrate for electrical connection. The surface of the circuit board 20 is adhered with an electrically conductive metallic film 21 for generating electrical signal input, thereby processing the related electrical signals. The electrically conductive metallic film 21 has a plurality of electrically conductive portions 210. Each of the electrically conductive portions 210 is arranged at intervals, thereby allow for the inputting of the respective electronic signals.

The soft light-guiding rubber layer 22 is provided on the circuit board 20 to correspond to the surface of the electrically conductive metallic film 21. In the present invention, the soft light-guiding rubber layer 22 has a plurality of protrusions. In the present embodiment, the protrusions are defined as protruding pillars 220. Each of the protruding pillars 220 is formed on the surface of the soft light-guiding rubber layer 22 and is arranged at intervals. In the present embodiment, all the protruding pillars 220 are provided on the soft light-guiding rubber layer 22 opposite to one surface of the circuit board 20. Each protruding pillar 220 corresponds to an electrically conductive portion 210 of the electrically conductive metallic film 21.

In the present invention, the soft light-guiding rubber layer 22 is made of a soft rubber material. The soft rubber material is a light-transmitting material (i.e. material with optical transparency) for guiding light. Since the soft light-guiding rubber layer 22 and the protruding pillars 220 are made of soft materials, elasticity can be generated when being pressed. Such elasticity is different from the elasticity generated by a common rubber. As a result, when each protruding pillar 220 is pressed by an external force, the soft light-guiding rubber layer 22 can be brought into contact with the electrically conductive portion 210 of the electrically conductive metallic film 21 easily. Therefore, the user can carry out an action for inputting key signals easily without exerting a large force. At the same time, a feedback feeling from the pressing action can be generated. Thus, the behavior of the present invention keypad module, specifically the elastic property usage thereof is different from that of a rubber material's common usage.

The light-emitting element 23 is provided on the circuit board 20 and corresponds to one side of the soft light-guiding rubber layer 22, thereby providing a light source for the soft light-guiding rubber layer 22. In the present embodiment, the light-emitting element 23 is a light-emitting diode or a light-emitting diode assembly having a plurality of colored light-emitting diodes with red, blue, or green light.

The optical touch layer 24 is provided on the soft light-guiding layer 22 by means of a printing or etching process. As shown in the drawings, in the present embodiment, the top surfaces of all protruding pillars 220 abut the optical touch layer 24, thereby generating an optically enhanced touch-control effect. In the present invention, the optical touch layer 24 is a touch film having an electrically conductive and light guiding effect resulting from optical transparency. Via the electrically conductive and light-guiding property, an optically enhanced touch-control effect is started. With the cooperation of each protruding pillar 220 of the soft light-guiding rubber layer 22, a feedback feeling from a pressing action can be generated. In the present embodiment, the touch film that has an electrically conductive and light guiding effect can be made of Indium Tin Oxide.

The key layer 26 is provided on the surface of the optical touch layer 24, thereby achieving and completing the optically enhanced touch-control and feedback effect. The key layer 26 has a body 260 and a plurality of keys 261 formed on the body 260. Each key 261 protrudes upwards from the body 260 and corresponds to each protruding pillar 220 of the soft light-guiding rubber layer 22. When a key 261 is pressed, the key can be brought into contact with each electrically conductive portion 210 of the electrically conductive metallic film 21 via the contact-sensing action of each corresponding protruding pillar 220. In this way, a contact for signal input is formed, thereby immediately generating a feedback feeling from a pressing action.

Via the above arrangement, when the key 261 of the key layer 26 is pressed by an external force, via the driving of the body 260 along with the touch-control of the optical touch layer 24, the protruding pillars 220 of the soft light-guiding rubber layer 22 are driven to be pressed. With the electrical contact between the electrically conductive portion 210 of the electrically conductive metallic film 21 and the circuit board 20, the signal for the pressing action is inputted into the electronic circuit, so that the mobile phone can display the corresponding function caused by pressing the key.

Furthermore, with the optically enhanced touch-control of the optical touch layer 24, the user can recognize the conditions of the pressed keys. At the same time, with the elasticity of the soft light-guiding rubber layer 22, a feedback feeling from a pressing action can be generated immediately, carries through to the optical touch layer 24, then be felt by user on the key pad layer 26. In this way, the user can carry out the action of inputting key signals easily.

Please refer to FIG. 5, which is an assembled view showing the keypad module of a mobile phone according to another embodiment of the present invention. As shown in this figure, the difference between the present embodiment and the previous embodiment is described as follows.

The soft light-guiding rubber layer 22 is designed in such a manner that each protruding pillar 220 is provided on the soft light-guiding rubber layer 22 to face the surface of the circuit board 20, and each protruding pillar 220 faces an electrically conductive portion 210 of the electrically conductive metallic film 21 respectively. Thus, via this arrangement, the present embodiment can achieve the same effect as that of the previous embodiment.

Furthermore, in the present invention, the soft light-guiding rubber layer 22 can be defined as a soft elastic layer or soft rubber layer. The soft elastic layer can be a transparent rubber material. The soft rubber layer can be a transparent material used for guiding light. Via this arrangement, a soft feedback feeling from a pressing action can be generated. In addition, an effect of guiding light can be also achieved.

According to the above, the present invention combines the soft light-guiding rubber layer, the optical touch layer, and the key layer to form a keypad module. The thus-formed keypad module has advantageous features as follows.

(I) Via the soft light-guiding rubber layer, the light-guiding effect and the feedback feeling from the pressing action on the keypad can be achieved. Furthermore, the thickness of the keypad module can be reduced.

(II) Via the optical touch layer (which is optically transparent and electrically conductive), the user is provided with an optically enhanced touch-control effect (the combination of light-guiding and touch control) and thus the user can understand the conditions of the pressed keys.

(III) Via the elasticity of the soft light-guiding rubber layer, the user only needs to press the key with a slight force so as to input signals.

While the present invention has been described in terms of what is presently considered to be the most practical and preferred embodiments, it is to be understood that the present invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-functional keypad module for a mobile phone, comprising:
a circuit board;
a light-emitting element electrically connected on the circuit board;
a soft light-guiding rubber layer provided on the circuit board, one side of the soft light-guiding rubber layer corresponding to the light-emitting element, the soft light-guiding rubber layer being provided with a plurality of protrusions, each of the protrusions being arranged at interval and facing the circuit board, thereby generating a feedback feeling from a pressing action;
an optical touch layer provided on the soft light-guiding rubber layer in order to initiate an optically enhanced touch-control effect, furthermore the optical touch layer on the soft light-guiding rubber layer continues the feedback feeling from the pressing action; and
a key layer provided on the optical touch layer to complete and achieve the optically enhanced touch-control effect, the key layer having a plurality of keys, each key corresponding to a protrusion respectively.

2. The multi-functional keypad module for a mobile phone according to claim 1, wherein the circuit board is provided with an electrically conductive metallic film corresponding to the soft light-guiding rubber layer.

3. The multi-functional keypad module for a mobile phone according to claim 2, wherein the surface of the electrically conductive metallic film has a plurality of electrically conductive portions, each protrusion of the soft light-guiding rubber layer corresponds to an electrically conductive portion, thereby generating a feedback feeling from a pressing action.

4. The multi-functional keypad module for a mobile phone according to claim 1, wherein the soft light-guiding rubber layer is constituted of a soft rubber material.

5. The multi-functional keypad module for a mobile phone according to claim. 4, wherein the soft rubber material is a material with optical transparency.

6. The multi-functional keypad module for a mobile phone according to claim 1, wherein the optical touch layer is a touch film that is electrically conductive and light guiding.

7. The multi-functional keypad module for a mobile phone according to claim 6, wherein the touch film that is electrically conductive and light guiding is constituted of Indium Tin Oxide.

8. The multi-functional keypad module for a mobile phone according to claim 1, wherein the light-emitting element is a light-emitting diode or a light-emitting diode assembly having a plurality of light-emitting diodes.

9. A multi-functional keypad module for a mobile phone, comprising:
a soft elastic layer having a plurality of protrusions;
an optical touch layer provided on the soft elastic layer, the optical touch layer and the soft elastic layer together forming a feedback feeling from a pressing action; and
a key layer provided on the optical touch layer, the key layer having a plurality of keys, and each key corresponding to one of the plurality of protrusions respectively.

10. The multi-functional keypad module for a mobile phone according to claim 9, wherein the soft elastic layer is a light-transmitting rubber material.

11. The multi-functional keypad module for a mobile phone according to claim 9, wherein the optical touch layer is a touch film that is electrically conductive and light-sensitive.

12. The multi-functional keypad module for a mobile phone according to claim 11, wherein the touch film that is electrically conductive and light-sensitive is constituted of Indium Tin Oxide.

13. The multi-functional keypad module for a mobile phone according to claim 9, further comprising a circuit board, the soft elastic layer being provided on the circuit board, and each of the plurality of protrusions corresponding to the circuit board.

14. The multi-functional keypad module for a mobile phone according to claim 13, wherein the circuit board is provided thereon with an electrically conductive metallic film, the electrically conductive metallic film has a plurality of electrically conductive portions, each electrically conductive portion corresponds to the plurality of protrusions of the soft elastic layer respectively.

15. The multi-functional keypad module for a mobile phone according to claim 13, further comprising a light-emitting element electrically connected on the circuit board, one side of the soft elastic layer corresponding to the light-emitting element.

16. The multi-functional keypad module for a mobile phone according to claim 15, wherein the light-emitting element is a light-emitting diode or a light-emitting diode assembly having a plurality of light-emitting diodes.

17. A multi-functional keypad module for a mobile phone, comprising:
a soft rubber layer;
an optical touch layer provided on the soft rubber layer; and
a key layer provided on the optical touch layer.

18. The multi-functional keypad module for a mobile phone according to claim 17, further comprising a circuit board, the soft elastic layer being provided on the circuit board, the circuit board having an electrically conductive film, the electrically conductive film having a plurality of electrically conductive portions, and the soft rubber layer having a plurality of protrusions, each of the plurality of protrusions corresponding to one of the electrically conductive portions respectively.

19. The multi-functional keypad module for a mobile phone according to claim 18, further comprising a light-emitting element electrically connected on the circuit board, the light-emitting element corresponding to one side of the soft rubber layer.

20. The multi-functional keypad module for a mobile phone according to claim 19, wherein the light-emitting element is a light-emitting diode or a light-emitting diode assembly having a plurality of light-emitting diodes.

21. The multi-functional keypad module for a mobile phone according to claim 18, wherein the key layer has a plurality of keys, each of the keys is arranged at intervals and corresponds to one of the plurality of protrusions respectively.

22. The multi-functional keypad module for a mobile phone according to claim 17, wherein the optical touch layer is a touch film that is electrically conductive and light guiding.

23. The multi-functional keypad module for a mobile phone according to claim 17, wherein the optical touch layer is constituted of Indium Tin Oxide.

24. The multi-functional keypad module for a mobile phone according to claim 17, wherein the soft rubber material is a material with optical transparency for guiding light.
